(19) United States
(12) Patent Application Publication
(10) Pub. No.: US 2013/0077801 A1
(43) Pub. Date: Mar. 28, 2013

(54) DISTORTION CONTROL TECHNIQUES AND CONFIGURATIONS

(71) Applicant: David James Tarnowski, Walnut Creek, CA (US)

(72) Inventor: David James Tarnowski, Walnut Creek, CA (US)

(21) Appl. No.: 13/623,005

(22) Filed: Sep. 19, 2012

Related U.S. Application Data
(60) Provisional application No. 61/626,313, filed on Sep. 23, 2011.

(51) Int. Cl. H04B 15/00

(52) U.S. Cl. 381/94.1

(57) ABSTRACT

Embodiments of the present disclosure provide distortion control techniques and configurations. An apparatus includes an input module configured to receive an audio signal, a clipping module configured to clip the audio signal and a control module configured to allow a user to control a clipping threshold. The clipping module is configured to clip the audio signal based on the clipping threshold. The clipping threshold is a voltage level corresponding with an amplitude level of the audio signal and the clipping threshold is a variable clipping threshold configurable by the user to correspond with multiple amplitude levels of the audio signal. Other embodiments may be described and/or claimed.

### CROSS REFERENCE TO RELATED APPLICATIONS

The present application claims priority to U.S. Provisional Patent Application No. 61/626,313, filed Sep. 23, 2011, the entire specification of which is hereby incorporated by reference in its entirety for all purposes.

### TECHNICAL FIELD

Embodiments of the present invention relate to audio signal processing, and in particular to user-configurable clipping and/or limiting distortion control techniques and configurations.

### BACKGROUND

Currently, clipping and/or limiting distortion of an audio signal can be produced using various means such as, for example, overdriving discrete or integrated amplifiers such as vacuum tubes, transistors, operational amplifiers, Norton amplifiers, or metal-oxide semiconductor (MOS) devices or by sending an audio signal to a clipping amplifier or diode limiters. Over many years, clipping techniques have focused on simulating vacuum tube clipping, which is a fixed threshold.

However, present clipping techniques may not allow a user of audio equipment that produces or plays back an audio signal to finely control, either directly or indirectly, a variable clipping threshold below which no distortion occurs and above which distortion occurs in a pre-amplifier device. Present clipping techniques may not provide a means for a user to directly or indirectly change on a continuous basis any threshold of clipping and may not provide a means for the user to modulate any threshold of clipping. Further, present clipping techniques may not provide a means for the user to directly or indirectly vary the threshold of clipping independent of the gain of the signal path or independent of an amplitude of the audio signal.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 is a schematic diagram of distortion control circuitry, in accordance with various embodiments of the invention.

FIG. 2 is a schematic diagram of a clipping circuit, in accordance with various embodiments of the invention.

FIG. 3 schematically illustrates an example system including distortion control circuitry, in accordance with various embodiments of the invention.

FIG. 4 schematically illustrates a process flow diagram of a method of clipping an audio signal, in accordance with various embodiments of the invention.

FIG. 5 illustrates an example processor system that can be used to control distortion of an audio signal, in accordance with various embodiments of the invention.

### DETAILED DESCRIPTION OF EMBODIMENTS

Embodiments of the present disclosure describe user-configurable clipping and/or limiting distortion control techniques and configurations. In the following detailed description, reference is made to the accompanying figures which form a part hereof wherein like numerals may designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

The terms “coupled” may be used in various embodiments. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in various embodiments,” which may each refer to one or more of the same or different embodiments. Furthermore, the terms “comprising,” “including,” “having,” and the like, as used with respect to embodiments of the present invention, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Embodiments of the present disclosure include example system, method, and apparatus that are configured to allow a user of an audio signal to directly or indirectly control a clipping threshold of the audio signal. Distortion threshold control as described herein may allow production of an audio signal that affords greater expression in the use of a musical instrument (e.g., microphone, guitar). For example, embodiments described herein may allow a guitar player to finely adjust the clipping threshold in accordance with the guitar player's playing style to produce an audio signal without distortion when strumming or picking at a desired level of softness and to produce an audio signal with distortion when playing with greater intensity of strumming or picking above the user-controlled distortion threshold.

Distortion control techniques and configurations described herein may provide a user with distortion control that is highly responsive to an amplitude level of the audio signal to deliver more volume dynamics, timbre, faster transients and richer harmonics. For example, a guitarist may set a variable clipping threshold to a level that allows expression of dynamics and tone ranging from clean sound to overdrive or full distortion sound according to the particular playing style of the guitarist by simply playing harder or softer and without any additional adjusting or modifying control of a signal path of the audio signal or a control path of a control signal by way of a knob, soft control, switch, or other means to create the effect. The clipping threshold may be finely tuned by the user to correspond with a particular intensity of strumming or plucking strings of a guitar. Thus, natural dynamics of the guitarist can be used to produce an organic, natural breakup or overdrive to occur when the guitarist picks the strings harder. A blues player, for example, can pick a note or chord to emphasize by simply striking the strings harder so they “grind” or “bite” more due to an increase in distortion and characteristics of distortion including, but not limited to, perceived loudness or harmonically rich transients.

A “user” as described herein may include anyone that controls the clipping threshold of the audio signal such as, for example, a musician or audio engineer/technician, according to various embodiments. An “audio signal” as described herein may include any electrical signal representative of audio including an analog signal or digital signal, according to various embodiments.

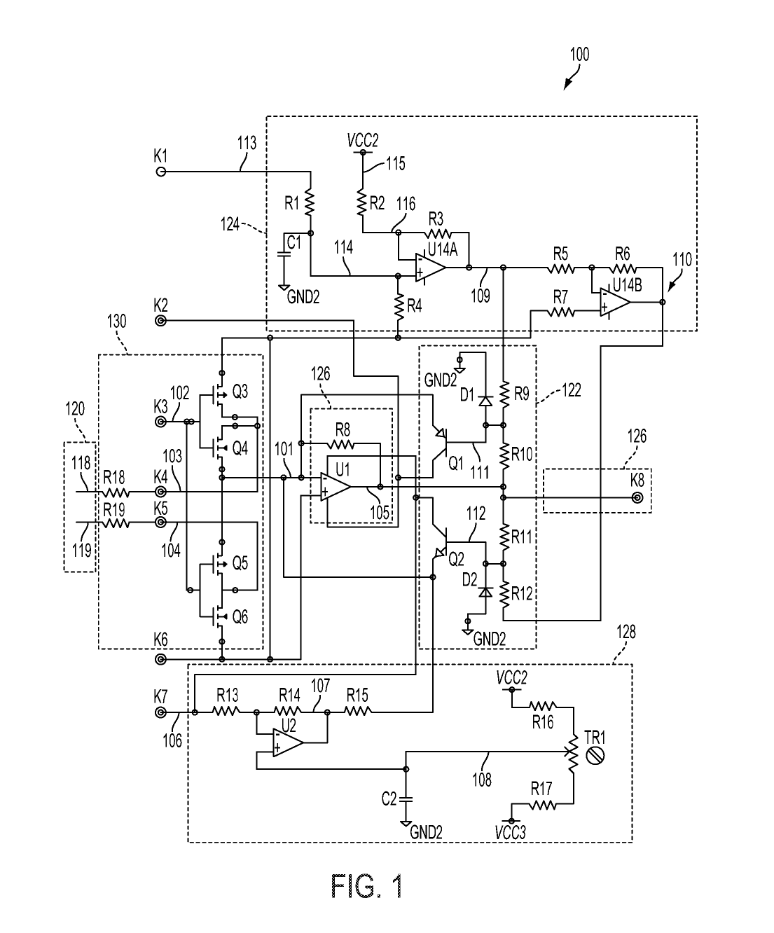

FIG. 1 is a schematic diagram of distortion control circuitry 100, in accordance with various embodiments of the invention. The distortion control circuitry 100 may represent a feedback limiter that is configured to limit a gain of an operational amplifier U1 in a close-loop configuration, in accordance with some embodiments.

The distortion control circuitry 100 may include an input module 120 configured to receive an audio signal, a clipping module 122 configured to clip the audio signal and a control module 124 configured to allow a user to control a clipping threshold of the clipping module 122. The clipping threshold may define a threshold level below which no clipping of the audio signal and above which clipping of the audio signal occurs (e.g., to provide “hard clipping”). The terms “below” and “above” as used in the previous sentence may be used in reference to an absolute value of an amplitude value of the audio signal in order to comprehend that, in some cases, the clipping threshold may correspond with a negative voltage and/or amplitude in some embodiments. The distortion control circuitry 100 may further include an output module 126 configured to output the audio signal from the clipping module 122 in some embodiments.

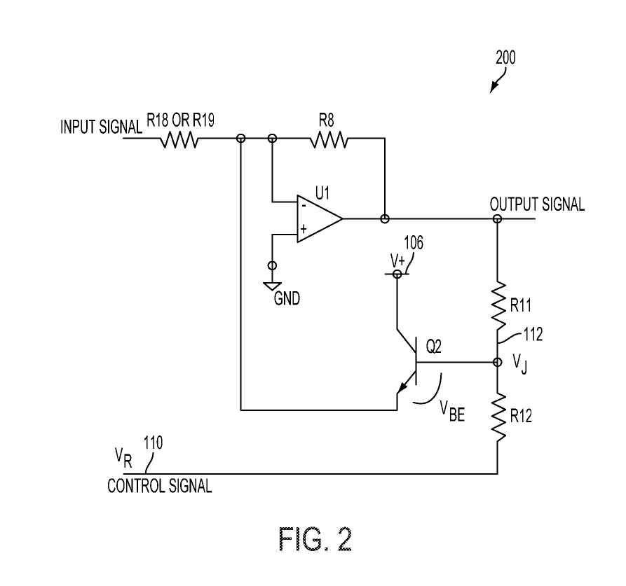

In the depicted embodiment, the input module 120 includes port 118 and port 119. The clipping module 122. includes resistors R9, R10, R11 and R12, transistors Q1 and Q2, and diodes D1 and D2. The clipping module 122. may further include operational amplifier U1. and/or other features described in connection with the clipping circuit 200. of FIG. 2. The control module 124 includes resistors R1, R2, R3, R4, R5, R6 and R7, capacitor C1, operational amplifiers U14A and U14B. The output module 126 includes operational amplifier U1. (line 105), resistor R8, and node K8.

The distortion control circuitry 100 may include additional functional modules in some embodiments. For example, in some embodiments, the distortion control circuitry 100 may further include a select module 130 coupled with the input module 120 and configured to select an audio signal for input to the clipping module 122. The distortion control circuitry 100 may further include an offset module 128 configured to amplify the audio signal symmetrically such that any signal clipping occurs evenly at a positive peak of the audio signal and a negative peak of the audio signal. While the circuitry corresponding to each module is generally demarcated with dashed lines in FIG. 1, in other embodiments, the circuitry corresponding to each module may include more or fewer features than depicted or may include alternative circuitry that is configured to perform a similar function.

The clipping module 122. may be configured to clip the audio signal based on the clipping threshold set by a user through the control module 124. In some embodiments, the clipping threshold may be a voltage level corresponding with an amplitude level of the audio signal. The clipping threshold may be a variable clipping threshold configurable by a user to correspond with multiple amplitude levels of the audio signal. For example, the clipping threshold may be continuously variable (e.g., analog), software variable (e.g., digital), step-variable or switch variable to provide a multitude of threshold steps. The variability of the clipping threshold may include, for example, time and/or amplitude variation or responsiveness to other signals related or unrelated to the audio signal that is input to the distortion control circuitry 100. The variability in control of the clipping threshold may allow a user to finely tune the clipping threshold to the particular style (e.g., playing or singing style) of an individual (e.g., the user in some embodiments) who produces an audio signal (e.g., plays a musical instrument or sings).

In some embodiments, the clipping module 122. is configured to clip the audio signal when a voltage corresponding with an amplitude of the audio signal exceeds the clipping threshold. The clipping threshold may be configurable by the user independent of gain (e.g., of a pre-amplifier device) and an input level of the audio signal. For example, in some embodiments, the clipping threshold may be set independent of setting a gain (e.g., in a clipping circuit executed in a feedback amplifier such as, for example, operational amplifier U1 of FIG. 1) or setting an input level of the audio signal. An input level (e.g., voltage level) of the audio signal may be set independently and separately from the clipping threshold using, for example, upstream gain circuitry and/or the feedback resistor (e.g., resistor R8) and/or the input resistor (e.g., resistor R19).

In some embodiments, port 118 and port 119 may each be configured to receive an audio signal. The port 118 may be coupled with the resistor R18 and the port 119 may be coupled with the resistor R19, in some embodiments. The resistor R18 may convert a voltage (e.g., a respective audio signal) received from the respective port 118 to a current in order to provide a current to line 101, which may be passed through a transistor Q4 for use by an operational amplifier U1. at a same node. The resistor R19 may perform a similar function for a voltage received on port 119. For example, a current may be provided at nodes K4 and K5 to respective lines 103 and 104 for respective ports 118 and 119. The select module 130 may be configured to select one of the input signals received on port 118 and port 119 for processing (e.g., clipping or limiting by the clipping module 122).

According to various embodiments, the select module 130 may include a current mode switch such as, for example, a metal-oxide-semiconductor field effect transistor (MOSFET) Q4 that is configured to connect an audio signal from node K4 to an input (e.g., line 101) of an operational amplifier U1. The MOSFET Q4 may be switched on or off by applying a logic signal to node K3 (e.g., via line 102), which may operate as a switching node. When MOSFET Q4 is in an “off” mode, MOSFET Q3 may serve to shunt the audio signal at node K4 (e.g., via line 103) to a low impedance ground and provide a high on-off ratio to the audio signal at node K4.

MOSFET Q5 may operate in a similar or same manner as MOSFET Q3 and MOSFET Q6 may operate in a similar or same manner as MOSFET Q4. In some embodiments, when MOSFET Q4 is “off,” MOSFET Q5 is “on.” MOSFETs Q4 and Q5 may form a single pole, double throw switch that may be configured to select an input audio signal to the operational amplifier U1. (e.g., via line 101) from either the audio signal at node K4 or node K5 via respective line 103 or line 104. The input audio signal at node K4 and node K5 may correspond with a respective first channel (Ch1) and second channel (Ch2) of a pre-amplifier device, in some embodiments.

The operational amplifier U1. may amplify the audio signal and output the audio signal on line 105. Resistor R8 may be coupled with the audio signal output from the operational amplifier U1 at line 105 and may serve as a feedback element, which may in part, determine the gain of the operational amplifier U1 with resistor R18 or resistor R19. For example, the ratio of either resistor R18 or resistor R19 to resistor R8 may set the gain of the operational amplifier. The operational amplifier U1 may be connected to a power supply (e.g., negative power supply for distortion control circuitry 100) provided by node K2 and a ground supply (e.g., ground supply for distortion control circuitry 100) provided by node K6. According to various embodiments, the distortion control circuitry 100 may be coupled with a positive supply voltage K7, line 106, a negative supply voltage K2 and a ground supply/node K6 that together powers the distortion control circuitry 100 and may be used as voltage references for voltage dividers (e.g., resistors R9, R10 and R11, R12) of the clipping module 122. In other embodiments, other types of suitable amplifiers may be used in place of operational amplifiers depicted in FIG. 1.

Operational amplifier U2 may be configured to provide a direct current (DC) signal to the operational amplifier U1 (e.g., via line 101) through resistor R15. The DC signal may provide a DC offset to the operational amplifier U1 at line 101. The DC signal may be derived from the voltage at node K7 and resistor R13 at line 106 and resistor R14 at line 107 working to set the gain of operational amplifier U2. A variable resistor TR1 may be adjusted (e.g., by a user) to provide a voltage on line 108 that offsets the operating point of the operational amplifier U1. Resistors R16 and R17 may be connected, as can be seen, at either end of the variable resistor TR1, which may function as a trimming potentiometer. The resistor R16 may be coupled with a power supply VCC2, a positive voltage source, and the resistor R17 may be coupled with another power supply VCC3, a negative voltage source. The resistors R16 and R17 may limit a minimum and maximum voltage at line 108 that can be set by the variable resistor TR1. A capacitor C2 may be coupled to line 108 to serve as a filter and remove noise from line 108. The capacitor C2 may be coupled with a ground supply (e.g., GND2). The variable resistor TR1 may be set to allow the operational amplifier U1 to amplify the audio signal input at line 101 symmetrically such that any signal clipping occurs evenly at a positive peak of the audio signal and a negative peak of the audio signal or the line 101 may be set to allow for asymmetrical clipping by the user.

In some embodiments, the variable resistor TR1 may be adjusted to bias the operational amplifier U1 to provide for asymmetrical clipping of the positive and negative peaks of the audio signal input at line 101. Asymmetrical clipping may produce a musically desirable distortion by changing the amplitude of the harmonics generated at clipping relative to the harmonics generated by symmetrical clipping. Asymmetrical clipping may be produced, for example, by adjusting the bias level of the audio signal by way of the line 107 at line 101 such that the clipping threshold level is reached at a lower point of the audio signal in the positive swing of the audio signal than the negative swing of the audio signal.

In some embodiments, the offset module 128 may be configurable by a user. For example, in some embodiments, multiple trimming means and/or a voltage port or a similar feature may be connected with the line 101 to accept voltages that are configurable by the user to produce an offset for operational amplifier U1 that provides symmetrical or asymmetrical clipping.

Resistor R9 and resistor R10 may be configured to serve as a voltage divider for the audio signal output from the operational amplifier U1 at line 105. The resistor R9 is connected on one end to a variable positive voltage reference derived by operational amplifier U14A at line 109. A value of the gain of the operational amplifier U14A may be set, at least in part, by resistor R3. The variable positive voltage reference at line 109 may further be connected to another operational amplifier U14B through resistor R5, as can be seen. Resistor R5 and resistor R6 may determine the gain of the operational amplifier U14B. In one embodiment, the gain (e.g., voltage ratio) of the operational amplifier U14B may be set to −1 (e.g., at line 110). Resistor R7 may provide a bias to operational amplifier U14B.

An output of the operational amplifier U14B at line 110 may be connected to one leg of a voltage divider formed by resistor R11 and resistor R12 configured in a similar manner as resistor R9 and resistor R10, but with opposite polarity. A voltage at the anode of diode D1 (e.g., at line 111) and a voltage of the cathode of diode D2 (e.g., at line 112) may vary in proportion to an amplitude of the audio signal at line 103 or line 104.

The signal at the anode of diode D1 may be connected to the base of transistor Q1 via line 111 and may be biased by resistor R9 and the voltage at line 109. The emitter of transistor Q1 may be connected to the inverting input of operational amplifier U1 at line 101 and may be in the feedback loop of the operational amplifier U1. In some embodiments, transistor Q1 is turned “on” to drive current into the operational amplifier's U1 pin 6 when a voltage at the base of the transistor Q1 swings negative, which may provide a feedback limiter means for clipping the audio signal. In some embodiments, the transistor Q1 may operate according to a user-configured clipping threshold for soft or hard clipping of the audio signal. The diode D1 may function as a protection device to prevent reverse voltage breakdown of the transistor Q1.

Transistor Q2 may function in a similar manner as transistor Q1, but for positive signal swings at the output of the operational amplifier U1 at line 105. In some embodiments, the transistor Q1 and transistor Q2 may each correspond with a variable clipping threshold configurable by a user. The transistor Q1 may correspond with a first clipping threshold, which may be a lower threshold having a negative voltage and the transistor Q2 may correspond with a second clipping threshold, which may be an upper threshold having a positive voltage. In other embodiments, the distortion control circuitry 100 may include additional transistors similar to transistors Q1 and/or Q2 configured to allow a user to separately adjust additional clipping thresholds of a plurality of clipping thresholds. The transistors Q1 and Q2 may be configured to hard clip the audio signal. The transistors Q1 and Q2 may be configured to amplify current in the feedback loop of the operational amplifier U1 when turned “on”, allowing a very abrupt transition from no clipping to full clipping. Audibly, such characteristic may allow a user to keep an audio signal free of distortion right up to the threshold level set or controlled by the user.

In other embodiments, the transistors Q1 and Q2 may be replaced with other features such as, for example, diodes or a similar feature to provide soft clipping of the audio signal. For example, in soft clipping, the clipping threshold may slightly increase or decrease relative to the amplitude of the audio signal. The diodes may include, for example, zener diodes, light-emitting diodes, transistors configured to operate as diodes, or combinations thereof.

The transistor Q1 may be configured to operate according to a first control signal and the transistor Q2 may be configured to operate according to a second control signal. The first and/or second control signal may be configurable by a user. In the depicted embodiment, for simplicity, the first control signal for transistor Q1 is converted to a proportional, negative control signal corresponding to the second control signal for transistor Q2. In other embodiments, a user may independently set the clipping threshold level of the positive and negative excursion (e.g., upper and lower thresholds) of the audio signal. For example, one may break the line 109 at the left side of resistor R5 and then use the disconnected side of resistor R5 for an independent receiver of a second control signal. In some embodiments, the clipping module 122. is configured to allow independent and variable control of a clipping threshold for each of a positive peak and negative peak of the audio signal. For example, a voltage means may be applied to the control line of positive peaks of the audio signal and applied to the control line of negative peaks of the audio signal.

Node K1 may be an input port configured to receive a control signal (e.g., voltage) that is configurable by the user to indicate one or more clipping thresholds. The control signal may be sent through resistor R1 via line 113. The control signal at line 114 may be filtered by the combination of resistor R1 and capacitor C1. The control signal may further be scaled by the combination of resistor R1 and resistor R4, which may form a voltage divider to operational amplifier U14A at line 114. A voltage (e.g., from power supply VCC2) at line 115 may pass through a resistor R2 to the inverting input of the operational amplifier U14A via line 116 and provide an offset means to the operational amplifier U14A when divided by resistor R2 and resistor R4 at line 114.

Thus, according to various embodiments, the distortion control circuitry 100 may be configured to receive an audio signal at input line 103 or line 104, process (e.g., clip) the audio signal via line 101 at operational amplifier U1 using transistors Q1 and Q2, and output the processed audio signal at line 105 to node K8. An amount and type of processing of the audio signal may depend on where a user sets the clipping threshold (e.g., via line 111 for a negative excursion of the audio signal and/or via line 112 for a positive excursion of the audio signal).

A clipping threshold above a ground reference of the positive excursion may be set by the output of operational amplifier U14B at line 110 and a clipping threshold below a ground reference of the negative excursion may be set by the output of operational amplifier U14A at line 109. The user may have access to and control of line 113, which controls line 109 and line 110 to provide variable threshold control as described herein. By varying the voltage at line 113, the user may control the clipping threshold of the audio signal. The transistors Q1 and Q2 of the clipping module 122. may be configured to operate in a negative feedback loop of operational amplifier U1, which is configured to receive the input audio signal at line 101 and output the processed audio signal at line 105.

Although the distortion control circuitry 100 of FIG. 1 depicts specific components and arrangements, alternative components and arrangements may be used in other embodiments to perform similar functions as described herein.

FIG. 2 is a schematic diagram of a clipping circuit 200. (e.g., limiting circuit), in accordance with various embodiments of the invention. The clipping circuit 200 may comport with embodiments described in connection with circuitry of the distortion control circuitry 100 of FIG. 1.

The clipping circuit 200 may include an operational amplifier U1 configured to receive an input signal (e.g., the audio signal), as can be seen. The input signal (e.g., voltage) may pass through resistor R18 or R19 to an input of the operational amplifier U1, as can be seen. Resistor R8 may be coupled with the output of the operational amplifier U1. and serve as a feedback element, which may in part, determine the gain of the operational amplifier U1.

An emitter of transistor Q2 may be connected to the inverting input of operational amplifier U1 and may be in the feedback loop of the operational amplifier U1. in some embodiments. The transistor Q2 may be further connected to a power supply (e.g., voltage V+, which may be a same voltage VCC2 of FIG. 1) at line 106, as can be seen. A base of the transistor Q2 may be coupled with line 112 between resistors R11 and R12, which are coupled with an output signal (e.g., the audio signal) from the operational amplifier U1 and a control signal, V_{R} (e.g., voltage), at line 110, as can be seen.

The voltage, Vⱼ, at line 112 may vary according to an amplitude of the audio signal. In some embodiments, the transistor Q2 may begin to conduct (e.g., turn “on”) when the voltage Vⱼ exceeds the voltage, V_{BE}, between the base and emitter of transistor Q2. The transistor Q2 may be configured to hard clip the audio signal when turned “on” in some embodiments.

According to various embodiments, the output signal (e.g., voltage representing the audio signal) of the operational amplifier U1 may be calculated or limited to a value according to the following where R₁₁ is a resistance of resistor R11, R₁₂ is a resistance of resistor R12, V_{BE} is a voltage between the base and emitter of transistor Q2, and V_{R} is a voltage on line 110:

$$( \frac{1 + {R}_{11}}{{R}_{12}} ) {V}_{BE} + \frac{{R}_{11}}{{R}_{12}} \cdot {V}_{R} \qquad ( 1 )$$

The gain of the operational amplifier U1 before limiting or clipping occurs (e.g., prior to turning “on” of transistor Q2) may be calculated according to one of the following where R₈ is a resistance of resistor R_{8,} R₁₈ is a resistance of resistor R18, and R₁₉ is a resistance of resistor R19:

$$\begin{matrix}\frac{{R}_{8}}{{R}_{18}} & ( 2 ) \\ \frac{{R}_{8}}{{R}_{19}} & ( 3 )\end{matrix}$$

Equation (2) may be used for an input signal received by the operational amplifier U1 over resistor R18 and Equation (3) may be used for an input signal received by the operational amplifier U1 over resistor R19.

The gain of the operational amplifier U1 after limiting or clipping occurs (e.g., subsequent to turning “on” of transistor Q2) may be calculated according to one of the following where R₈ is a resistance of resistor R8, R₁₁ is a resistance of resistor R11, R₁₈ is a resistance of resistor R18, and R₁₉ is a resistance of resistor R19:

$$\begin{matrix}\frac{{R}_{8} \cdot {R}_{11}}{{R}_{18} \cdot ( {R}_{8} + {R}_{11} )} & ( 4 ) \\ \frac{{R}_{8} \cdot {R}_{11}}{{R}_{19} \cdot ( {R}_{8} + {R}_{11} )} & ( 5 )\end{matrix}$$

Equation (4) may be used for an input signal received by the operational amplifier U1 over resistor R18 and Equation (5) may be used for an input signal received by the operational amplifier U1 over resistor R19. Although FIG. 2 describes a configuration including transistor Q2, which is turned “on” to drive current into the operational amplifier's U1 pin 6 when a voltage at the base of the transistor Q2 swings positive, similar principles may apply to a configuration including transistor Q1 of FIG. 1, which is turned “off” to drive current into the operational amplifier's U1 pin 6 when a voltage at the base of the transistor Q1 swings negative.

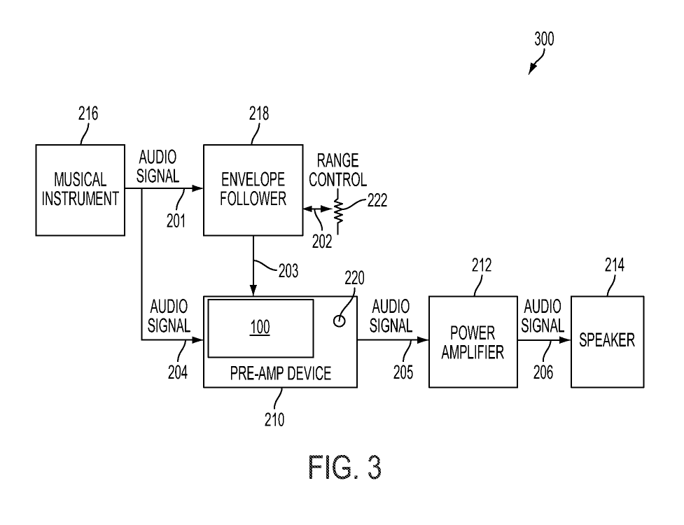

FIG. 3 schematically illustrates an example system 300 including distortion control circuitry 100, in accordance with various embodiments of the invention. The distortion control circuitry 100 may comport with embodiments described in connection with FIGS. 1-2.

According to various embodiments, the system 300 includes a pre-amplifier (pre-amp) device 210 including distortion control circuitry 100. In some embodiments, the pre-amplifier device 210 may be, include, or be part of a pedal (e.g., effects pedal) in some embodiments. In some embodiments, the pre-amplifier device 210 may include a knob 220, or other user interface, that is coupled with or is part of the control module (e.g., control module 124 of FIG. 1) of the distortion control circuitry 100. The knob 220 may be configurable by a user of the pre-amplifier device 210 to directly control a clipping threshold. In embodiments that allow a user to separately control multiple clipping thresholds, multiple knobs or user interfaces may be provided to correspond with the multiple clipping thresholds. Subject matter of the present disclosure is not limited to an effects pedal format and may include, in other embodiments, a signal processor including, but not limited to a preamplifier, amplifier, effects pedal or software user interface.

According to various embodiments, the system 300 may further include an instrument such as, for example, a musical instrument 216 or other source of an audio signal. The musical instrument 216 may be connected with the pre-amplifier device 210 to provide an audio signal to an input of the pre-amplifier device 210 using line 204. The input of the pre-amplifier device may be an input port coupled with the input module (e.g., input module 120 of FIG. 1) of the distortion control circuitry 100.

According to various embodiments, the system 300 may further include an envelope follower 218. In some embodiments, an envelope follower 218, also referred to as an envelope detector, may be coupled with the pre-amplifier device 210 using line 203. In some embodiments, the envelope follower 218 may be configured to receive a same input audio signal on line 201 that is input to the pre-amplifier device 210 on line 204.

The envelope follower 218 may be configured to produce an output signal (e.g., electrical signal) on line 203 that is an envelope of an audio signal received on line 201. The envelope follower 218 may, for example, receive the audio signal over line 201 at an input port of the envelope follower 218 and process the audio signal to produce an output signal on line 203 that represents an integral of a rectified audio signal or other processed signal. The output signal from the envelope follower 218 on line 203 may be coupled with the control module (e.g., the control module 124 of FIG. 1) of the distortion control circuitry 100 of the pre-amplifier device to allow a user to indirectly control a clipping threshold of the distortion control circuitry 100 using the envelope follower 218. For example, the output signal on line 203 may be coupled with an input port (e.g., control input) of the pre-amplifier device 210 that is coupled with the control module of the distortion control circuitry 100. The output signal on line 203 from the envelope follower 218 may serve as a control signal for the control module of the distortion control circuitry 100 in some embodiments.

In other embodiments, other devices (e.g., bandpass filter, etc.) may be coupled with the pre-amplifier device 210 to provide a control signal that indirectly controls a clipping threshold of the distortion control circuitry 100. In one embodiment, the control signal may be a modulation signal, phase-shifted audio signal, filtered audio signal, or combinations thereof. In one embodiment, a variable rate oscillator configured to vary output waveforms may be coupled with the threshold control means (e.g., control module 124 of FIG. 1) to produce a type of tremolo used in processing an audio signal. In addition to providing a commonly modulated amplitude of the audio signal, such configuration may allow modulation of harmonics of the audio signal that are generated by the clipping means (e.g., the clipping module 122 of FIG. 1). Soft clipping means (e.g., diodes in place of transistors Q1 and Q2 in FIG. 1) may be used to enhance the audio signal to create a different dynamic when the user-set clipping threshold is approached by the amplitude of the audio signal. The control signal may include other suitable types of signals and be produced by self-contained controls or remote controls in various embodiments.

A range control 222 may be coupled with the envelope follower 218 using line 202. The range control 222 may allow a user to adjust a range of voltages or currents for the audio signal received on line 201 to affect processing of the output signal on line 203 and, thus, indirectly control the clipping threshold or thresholds of the distortion control circuitry 100 through the envelope follower 218. In some embodiments, the range control 222 may include one or more resistors and may be configured to output one or more control signals to the envelope follower 218. As a frequency or amplitude of the audio signal on line 201 varies over time (e.g., according to playing of the musical instrument 216), the output signal on line 203 may follow the variations in response to the input signal. The output signal on line 203, by connection to the control module of the distortion control circuitry 100 may change an amount and character of distortion produced for the audio signal input on line 204 to the pre-amplifier device 210 and output on line 205.

The system 300 may further include a power amplifier 212, recording equipment such as, for example, a mixing console or other electronic amplifying device coupled with the pre-amplifier device 210 to receive the audio signal output on line 205. In some embodiments, the power amplifier 212 may be part of the recording equipment. The power amplifier 212 may be configured to increase power of the audio signal output by the output module (e.g., output module 126 of FIG. 1) of the distortion control circuitry 100.

The system 300 may further include a speaker 214 coupled coupled with the power amplifier 212 to receive the audio signal out put from the power amplifier 212 on line 206. The speaker 214 may be configured to produce sound based on the audio signal. In some embodiments, the sound produced by the speaker 214 may include distortion based on clipping of the audio signal made by the distortion control circuitry 100.

In some embodiments, lines 201, 202, 203, 204, 205 and 206 may represent external wiring such as cable (e.g., an audio cable for an audio signal). In other embodiments, lines 201, 202, 203, 204, 205 and 206 may represent internal wiring of the musical instrument 216, the envelope follower 218, the pre-amplifier device 210, the power amplifier 212 and the speaker 214. For example, in some embodiments, the pre-amplifier device 210 may be part of the musical instrument 216 or the power amplifier 212, the speaker 214 may be part of the power amplifier 212, the envelope follower 218 may be part of the musical instrument 216 or the pre-amplifier device 210. That is, one or more of the musical instrument 216, the envelope follower 218, the pre-amplifier device 210, the power amplifier 212 and the speaker 214 may be housed within a same enclosure and coupled together with internal wiring.

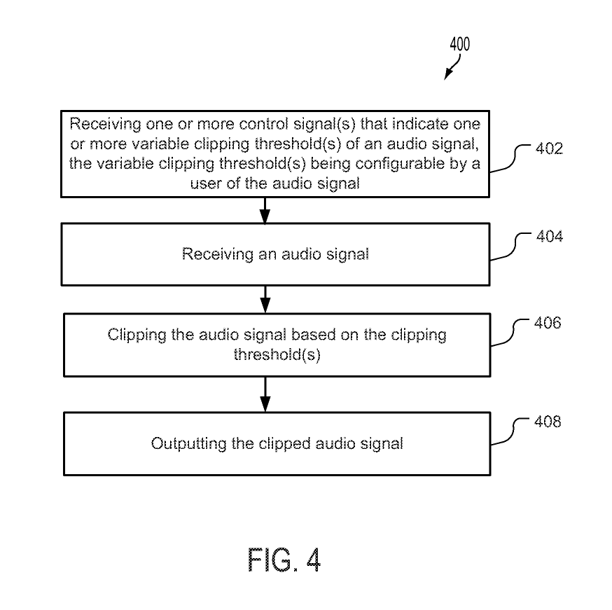

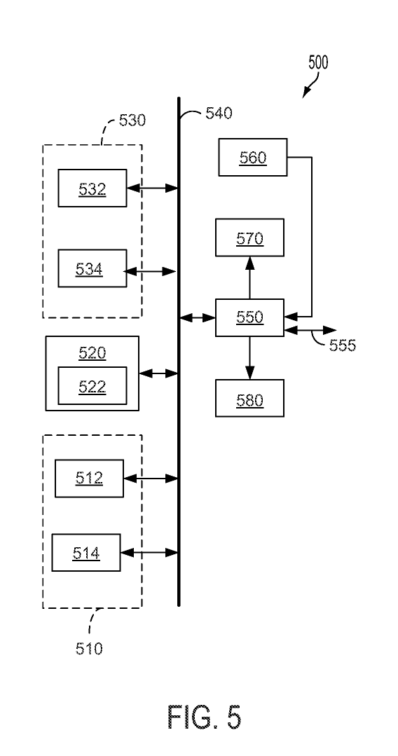

FIG. 4 schematically illustrates a process flow diagram of a method 400 of clipping an audio signal, in accordance with various embodiments of the invention. The method 400 may comport with embodiments described in connection with FIGS. 1-3. In some embodiments, the method 400 may include actions performed by distortion control circuitry (e.g., distortion control circuitry 100 of FIGS. 1 and 3 or clipping circuit 200 of FIG. 2) of a pre-amplifier device (e.g., pre-amplifier device 210 of FIG. 3). In other embodiments, the actions of method 400 or other actions described herein may be performed by a processor (e.g., processor 520 of FIG. 5) executing instructions stored on an article of manufacture such as, for example, a non-transitory storage medium (e.g., main memory 530 of FIG. 5).

At 402, the method 400 includes receiving one or more control signal(s) that indicate one or more variable clipping threshold(s) of an audio signal, the variable clipping threshold(s) being configurable by a user of the audio signal. The method 400 may include receiving a control signal that indicates a variable clipping threshold of the audio signal. In some embodiments, the control signal may be received by a control module (e.g., control module 124 of FIG. 1) of distortion control circuitry in a pre-amplifier device. The clipping threshold may be a voltage level corresponding with an amplitude level of the audio or a digital value representative of the same, according to various embodiments. In some embodiments, the clipping threshold may be a variable clipping threshold configurable by the user to correspond with multiple amplitude levels of the audio signal.

At 404, the method 400 may further include receiving an audio signal. The audio signal may be received by an input module (e.g., input module 120 of FIG. 1) of the distortion control circuitry in the pre-amplifier device in some embodiments. In some embodiments, the audio signal and the control signal may be in analog or digital format.

At 406, the method 400 may further include clipping the audio signal based on the clipping threshold. In some embodiments, the audio signal may be clipped by a clipping module (e.g., clipping module 122 of FIG. 1) of the distortion control circuitry in the pre-amplifier device.

At 408, the method 400 may further include outputting the clipped audio signal. In some embodiments, the clipped audio signal may be output by an output module (e.g., output module 126 of FIG. 1) of the distortion control circuitry in the pre-amplifier device.

Various operations may be described as multiple discrete operations in turn, in a manner that may be helpful in understanding embodiments of the present invention; however, the order of description should not be construed to imply that these operations are order dependent. For example, in some embodiments, receiving the audio signal at 404 may be performed prior to or at a same time as receiving a control signal at 402.

FIG. 5 illustrates an example processor system 500 that can be used to control distortion of an audio signal, in accordance with various embodiments of the invention. The processor system 500 may be a desktop computer, a laptop computer, a handheld computer, a tablet computer, a personal digital assistant (PDA), a server, an Internet appliance, and/or any other type of computing device.

The processor system 500 illustrated in FIG. 5 may include a chipset 510, which may includes a memory controller 512 and an input/output (I/O) controller 514. The chipset 510 may provide memory and I/O management functions as well as a plurality of general purpose and/or special purpose registers, timers, etc. that are accessible or used by a processor 520. The processor 520 may include a cache 522, which may be implemented using a first-level unified cache (L1), a second-level unified cache (L2), a third-level unified cache (L3), and/or any other suitable structures to store data.

The memory controller 512 may perform functions that enable the processor 520 to access and communicate with a main memory 530 including a volatile memory 532 and a non-volatile memory 534 via a bus 540. While FIG. 5 shows a bus 540 to communicatively couple various components to one another, other embodiments may include additional/alternative interfaces. The main memory 530 may include an article of manufacture (e.g., non-transitory storage medium) that is configured to store instructions, that if executed (e.g., by processor 520), result in actions described herein (e.g., method 400 of FIG. 4).

The volatile memory 532 may be implemented by synchronous dynamic random access memory (SDRAM), dynamic random access memory (DRAM), and/or any other type of random access memory device. The non-volatile memory 534 may be implemented using flash memory, read only memory (ROM), electrically erasable programmable read only memory (EEPROM), and/or any other desired type of memory device.

The processor system 500 may also include an interface circuit 550 that is coupled to the bus 540. The interface circuit 550 may be implemented using any type of interface standard such as an Ethernet interface, a universal serial bus (USB), a third generation input/output interface (3GIO) interface, and/or any other suitable type of interface.

One or more input devices 560 may be connected to the interface circuit 550. The input device(s) 560 may permit an individual to enter data and commands into the processor 520. For example, the input device(s) 560 may be implemented by a keyboard, a mouse, a touch-sensitive display, a track pad, a track ball, an isopoint, and/or a voice recognition system.

One or more output devices 570 may also be connected to the interface circuit 550. For example, the output device(s) 570 may be implemented by display devices (e.g., a light emitting display (LED), a liquid crystal display (LCD), a cathode ray tube (CRT) display, a printer and/or speakers). The interface circuit 550 may include, among other things, a graphics driver card.

The processor system 500 may also include one or more mass storage devices 580 to store software and data. Examples of such mass storage device(s) 580 include floppy disks and drives, hard disk drives, compact disks and drives, and digital versatile disks (DVD) and drives.

Access to the input device(s) 560, the output device(s) 570, the mass storage device(s) 580 and/or the network may be controlled by the I/O controller 514. In particular, the I/O controller 514 may perform functions that enable the processor 520 to communicate with the input device(s) 560, the output device(s) 570, the mass storage device(s) 580 and/or a network via the bus 540 and the interface circuit 550 (e.g., over wired or wireless communication 555).

While the components shown in FIG. 5 are depicted as separate blocks within the processor system 500, the functions performed by some of these blocks may be integrated within a single semiconductor circuit or may be implemented using two or more separate integrated circuits. For example, although the memory controller 512 and the I/O controller 514 are depicted as separate blocks within the chipset 510, the memory controller 512 and the I/O controller 514 may be integrated within a single semiconductor circuit.

According to various embodiments, the processor 520, the main memory 530, or the chipset 510, or combinations thereof, may be configured to perform actions described herein to provide user-configurable distortion control.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. An apparatus, comprising:
an input module configured to receive an audio signal;
a clipping module configured to clip the audio signal; and
a control module configured to allow a user to control a clipping threshold, wherein the clipping module is configured to clip the audio signal based on the clipping threshold, the clipping threshold is a voltage level corresponding with an amplitude level of the audio signal and the clipping threshold is a variable clipping threshold configurable by the user to correspond with multiple amplitude levels of the audio signal.

2. The apparatus of claim 1, wherein the variable clipping threshold is configurable by the user independent of setting gain of the apparatus or an input level of the audio signal.

3. The apparatus of claim 1, wherein:
the clipping threshold is a first clipping threshold of a plurality of clipping thresholds; and
other individual clipping thresholds of the plurality of clipping thresholds are configurable by the user.

4. The apparatus of claim 3, wherein:
the first clipping threshold is an upper threshold having a positive voltage; and
a second clipping threshold of the plurality of clipping thresholds is a lower threshold having a negative voltage.

5. The apparatus of claim 1, wherein the clipping threshold defines a threshold level below which no clipping of the audio signal occurs and above which clipping of the audio signal occurs.

6. The apparatus of claim 1, wherein:
the clipping module is configured to clip the audio signal when a voltage corresponding with an amplitude of the audio signal exceeds the clipping threshold; and
the clipping module is configured to receive a control signal from the control module, the control signal to indicate the clipping threshold.

7. The apparatus of claim 1, wherein the clipping module is configured to asymmetrically clip the audio signal.

8. The apparatus of claim 1, wherein the input module comprises:
a first port configured to receive a first audio signal; and
a second port configured to receive a second audio signal.

9. The apparatus of claim 8, further comprising:
a select module including circuitry that is configured to select one of the first audio signal or the second audio signal for processing by the clipping module.

10. The apparatus of claim 8, further comprising:
an offset module including circuitry that is configurable to provide symmetric or asymmetric clipping of the first audio signal or the second audio signal.

11. The apparatus of claim 10, wherein the offset module is configurable by the user to provide the symmetric or asymmetric clipping.

12. The apparatus of claim 9, wherein the clipping module comprises:
an amplifier configured to receive the first audio signal or the second audio signal;
a first transistor coupled with the amplifier to provide a first clipping threshold having a positive voltage; and
a second transistor coupled with the amplifier to provide a second clipping threshold having a negative voltage, wherein the first transistor and the second transistor are configured to operate in a negative feedback loop of the amplifier.

13. The apparatus of claim 12, wherein the amplifier is an operational amplifier.

14. The apparatus of claim 12, wherein the control module comprises:
a first operational amplifier having an output coupled with an input of the first transistor; and
a second operational amplifier having an output coupled with an input of the second transistor, wherein the output of the first operational amplifier and the second operational amplifier is configurable by the user.

15. The apparatus of claim 12, further comprising an output module configured to output the audio signal from the clipping module, the output module comprising:
an output line of the operational amplifier; and
a resistor coupled to the output line and an input line of the operational amplifier, the input line being configured to input the audio signal to the operational amplifier.

16. The apparatus of claim 1, wherein the clipping module is disposed within a pre-amplifier device.

17. The apparatus of claim 16, wherein the pre-amplifier device is an effects pedal.

18. The apparatus of claim 17, wherein the control module is coupled with a knob on the effects pedal that is configurable by the user to control the clipping threshold.

19. A system comprising:
a pre-amplifier device comprising:
an input module configured to receive an audio signal,
a clipping module configured to clip the audio signal,
a control module configured to allow a user to control a clipping threshold, wherein the clipping module is configured to clip the audio signal based on the clipping threshold, the clipping threshold is a voltage level corresponding with an amplitude level of the audio signal and the clipping threshold is a variable clipping threshold configurable by the user to correspond with multiple amplitude levels of the audio signal, and
an output module configured to output the audio signal from the clipping module; and
a power amplifier coupled with the pre-amplifier device and configured to increase power of the audio signal output by the output module.

20. The system of claim 19, further comprising:
a speaker coupled with the power amplifier and configured to receive the audio signal from the power amplifier.

21. The system of claim 19, further comprising:
recording equipment coupled with the power amplifier and configured to receive the audio signal from the power amplifier.

22. The system of claim 19, further comprising:
an instrument configured to produce the audio signal, wherein the input module of the pre-amplifier device is configured to receive the audio signal produced by the instrument.

23. The system of claim 22, wherein:
the control module includes means configurable by the user to directly control the clipping threshold; and
the user at least includes a user of the instrument.

24. The system of claim 22, further comprising:
an envelope follower coupled with the control module of the pre-amplifier device and the instrument, wherein the envelope follower is configured to receive and process the audio signal from the instrument and output the processed audio signal to the control module and wherein the control module is configured to allow the user to indirectly control the clipping threshold using the envelope follower.

25. A method, comprising:
receiving a control signal;
receiving an audio signal, wherein the control signal indicates a clipping threshold of the audio signal, the clipping threshold being configurable by a user of the audio signal, wherein the clipping threshold is a voltage level corresponding with an amplitude level of the audio signal and the clipping threshold is a variable clipping threshold configurable by the user to correspond with multiple amplitude levels of the audio signal; and
clipping the audio signal based on the clipping threshold.

26. The method of claim 25, further comprising:
outputting the clipped audio signal.

27. A machine-readable storage medium having instructions stored thereon that if executed by a processor result in:
receiving an audio signal;
receiving a control signal that indicates a clipping threshold of the audio signal, the clipping threshold being configured by a user of the audio signal, wherein the clipping threshold corresponds with an amplitude level of the audio signal and the clipping threshold is a variable clipping threshold configurable by the user to correspond with multiple amplitude levels of the audio signal; and
clipping the audio signal based on the clipping threshold.

28. The machine-readable storage medium of claim 27, wherein the audio signal and the control signal are in digital format.

29. The machine-readable storage medium of claim 27, wherein receiving the control signal comprises receiving a modulation signal.
